(19) United States
(12) Patent Application Publication
(10) Pub. No.: US 2012/0009550 A1
(43) Pub. Date: Jan. 12, 2012

(54) PERSONAL WELLBEING DEVICE AND SYSTEM

(75) Inventor: Noel G. GAYLE, Dacula, GA (US)

(73) Assignee: eLiving, LLC, Charlotte, NC (US)

(21) Appl. No.: 13/153,658

(22) Filed: Jun. 6, 2011

Related U.S. Application Data
(60) Provisional application No. 61/363,468, filed on Jul. 12, 2010.

(51) Int. Cl. G09B 19/00

(52) U.S. Cl. 434/127

(57) ABSTRACT

A device, a system and a computer program are provided for accepting and collecting demographic, OTC drug, prescription, and medical condition data, and outputting nutritional products, recipes, programs, meals, shopping lists, restaurant menus, and the like, designed for each unique user.

### CROSS REFERENCE TO PRIOR APPLICATIONS

This application claims priority and the benefit thereof from U.S. Provisional Application No. 61/363,468, filed on Jul. 12, 2010, and entitled “PERSONAL WELLBEING DEVICE AND SYSTEM,” the entirety of which is hereby incorporated herein by reference.

### FIELD OF THE DISCLOSURE

The present disclosure relates to a device, a system and a computer program for exchanging information related to personal nutrition, health and wellbeing. Moreover, the disclosure relates to collecting demographic data, over-the-counter (OTC) drug data, prescription data, medical conditions data and providing tailored nutritional products, recipes, programs, meals, shopping lists, restaurant menus, and the like, designed for each unique user.

### BACKGROUND OF THE DISCLOSURE

It is common knowledge that many health problems can be prevented or alleviated with a healthy diet. Nutrition is the provision of materials to cells and organisms that are necessary to support life. The materials are usually provided in the form of consumable food. Inadequate nutrition can have an injurious impact on the health of individuals, causing deficiency diseases, such as, for example, scurvy, beriberi, kwashiorkor, and the like, or chronic systemic diseases, such as, for example, cardiovascular disease, diabetes, osteoporosis, and the like. Improper nutrition can also cause health-threatening conditions such as, for example, obesity, metabolic syndrome, and the like.

There exist systems that capture a subset of demographic information to configure product offerings. For example, “NUTRISYSTEM D” captures the fact that a person is a diabetic and offers a set of meals designed for that condition. However, these existing systems are unable to provide comprehensively tailored product offerings to users.

The present disclosure provides a device, a system and a computer program for exchanging information related to personal nutrition, health and wellbeing, and for assisting individuals in meeting their individual, unique nutritional and health needs.

### SUMMARY OF THE DISCLOSURE

A device, a system and a computer program are provided for accepting and collecting demographic, OTC drug, prescription, and medical condition data, and outputting nutritional products, recipes, programs, meals, shopping lists, restaurant menus, and the like, designed for each unique user.

According to an aspect of the disclosure, a personal nutrition, health and wellbeing device is disclosed that receives user information and provides filtered conditional-based user data to a user based on the user information. The device comprises: a data transformer that retrieves source data from a database and generates user criteria based on the user information and the source data; a nutrient-caloric intake processor that receives the user criteria from the data transformer and processes the user criteria against nutrient and caloric information to generate nutrient and caloric intake data; and a business rules processor that generates the filtered conditional-based user data based on the nutrient and caloric intake data and sends the filtered conditional-based user data to a user interface device. The user information may comprise: a height of the user; a gender of the user; a date of birth date of the user; a family history of the user; a race of the user; a weight of the user; a goals and food history of the user; a lifestyle criteria of the user; a drug to be taken by the user; a dosage of the drug; a supplement to be taken by the user; a medical condition of the user; or an allergy of the user. The filtered conditional-based user data may comprise: a recipe; a meal plan; a diet plan; a nutritional conflict; an exercise routine; a shopping list; or a restaurant menu.

The personal nutrition, health and wellbeing device may further comprise a threshold determiner that receives the user criteria from the data transformer and the nutrient and caloric intake data from the nutrient-caloric intake processor and determines caloric and nutrient intake thresholds for the user.

The personal nutrition, health and wellbeing device may further comprise a drug impact processor that receives a nutrient impact data request for a nutrient and generates drug impact data for the nutrient; a drug interaction processor that receives the user criteria from the data transformer and the nutrient impact data from the drug impact processor and generates drug interaction data; a food-nutrient-drug processor that receives the drug interaction data from the drug interaction processor and generates a list of food and nutrients that may impact a drug; and a recipe and meal plan processor that receives the caloric and nutrient intake thresholds for the user from the threshold determiner, the list of food and nutrients that may impact the drug, and generates pre-filtered output data, wherein the filtered conditional-based user data is generated based on the pre-filtered output data.

The personal nutrition, health and wellbeing device may comprise a drug impact processor that receives a nutrient impact data request for a nutrient and generates drug impact data for the nutrient.

The personal nutrition, health and wellbeing device may further comprise a drug interaction processor that receives the user criteria from the data transformer and the nutrient impact data from the drug impact processor and generates drug interaction data.

The personal nutrition, health and wellbeing device may further comprise a food-nutrient-drug processor that receives the drug interaction data from the drug interaction processor and generates a list of food and nutrients that may impact a drug.

The personal nutrition, health and wellbeing device may further comprise a food-nutrient-allergy processor that receives the nutrient impact data and generates a list of food and nutrients that may impact an allergy or a condition of the user.

According to another aspect of the disclosure, a method is disclosed that provides information related to personal nutrition, health and wellbeing of a user. The method comprises: receiving user information from a user interface device; generating a user profile based on the user information; retrieving source data from a database; determining nutrient and caloric intake data based on the user profile and the retrieved source data; generating filtered conditional-based data based on the nutrient and caloric intake data and the user profile; and sending the filtered conditional-based data to the user interface device. The user information may comprise: a height of the user; a gender of the user; a date of birth date of the user; a family history of the user; a race of the user; a weight of the user; a goals and food history of the user; a lifestyle criteria of the user; a drug to be taken by the user; a dosage of the drug; a supplement to be taken by the user; a medical condition of the user; or an allergy of the user. The filtered conditional-based user data may comprise: a recipe; a meal plan; a diet plan; a nutritional conflict; an exercise routine; a shopping list; or a restaurant menu.

The generating the filtered conditional-based data based on the nutrient and caloric intake data and the user profile may comprise: generating a business rule based on a retrieved bench mark; and applying the business rule to pre-filtered output data to generate the filtered conditional-based data.

The method may further comprise: determining drug interaction data based on the user profile and the retrieved source data; and/or determining nutrient impact data based on the user profile and the retrieved source data.

The may further comprise: determining a nutrient intake threshold or a caloric intake threshold based on the nutrient and caloric intake data; and/or generating a list of foods and nutrients for a drug based on the drug interaction data and the user profile.

The method may further comprise generating a list of foods and nutrients for an allergy or a condition based on the nutrient impact data and the user profile.

According to a still further aspect of the disclosure, a computer readable medium is disclosed that comprises a computer program for providing information related to personal nutrition, health and wellbeing of a user. The computer readable medium comprises: a user information receiving code section that, when executed on a computer, receives user information from a user interface device; a user profile generating code section that, when executed on the computer, generates a user profile based on the user information; a source data retrieving code section that, when executed on the computer, retrieves source data from a database; a nutrient and caloric intake determining code section that, when executed on the computer, determines nutrient and caloric intake data based on the user profile and retrieved source data; a filtered conditional-based data generating code section that, when executed on the computer, generates filtered conditional-based data based on the nutrient and caloric intake data and the user profile; and a filtered conditional-based data sending code section that, when executed on the computer, sends the filtered conditional-based data to the user interface device.

The computer readable medium may further comprise: a drug interaction determining code section that, when executed on the computer, determines a drug interaction based on the user profile and the retrieved source data; a nutrient impact determining code section that, when executed on the computer, determines a nutrient impact based on the user profile and the retrieved source data; a nutrient and caloric intake threshold determining code section that, when executed on the computer, determines a nutrient intake threshold or a caloric intake threshold based on the nutrient and caloric intake data; a list of foods and nutrients for a drug generating code section that, when executed on the computer, generates a list of foods and nutrients for a drug based on the drug interaction and the user profile; a list of foods and nutrients for an allergy or condition generating code section that, when executed on the computer, generates a list of foods and nutrients for an allergy or a condition based on the nutrient impact and the user profile.

Additional features, advantages, and embodiments of the disclosure may be set forth or apparent from consideration of the detailed description and drawings. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a conditional system, according to principles of the disclosure;

FIG. 2 shows an example of medical criteria that may be used to process received source data;

FIG. 3 shows an example of an user profile, according to principles of the disclosure;

FIGS. 4A-4C show an example of a flow diagram of a conditional engine provided in the condition system of FIG. 1, according to principles of the disclosure;

FIG. 5 shows an example of a process for generating and outputting a host of custom-tailored recipes, meal plans, programs, activities, analytics, and the like, to each user, according to principles of the disclosure;

FIG. 6 shows another example of a process for generating and outputting a host of custom-tailored recipes, meal plans, programs, activities, analytics, and the like, to each user, according to principles of the disclosure;

FIG. 7 shows a representation of the seven layer OSI model;

FIG. 8 shows an example of a communication system according to principles of the disclosure; and

FIG. 9 shows an example of a process that may be carried out on a user interface (UI) device shown in FIG. 8, according to principles of the disclosure.

The present disclosure is further described in the detailed description that follows.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device configured to communicate over a communication link. The electronic device may include, for example, but is not limited to, a mobile telephone, a personal data assistant (PDA), a mobile computer, a stationary computer, a smart phone, mobile station, user equipment, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often wider heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “network,” as used in this disclosure, means an arrangement of two or more communication links. A network may include, for example, the Internet, a local area network (LAN), a wide area network (WAN), a metropolitan area network (MAN), a personal area network (PAN), a campus area network, a corporate area network, a global area network (GAN), a broadband area network (BAN), any combination of the foregoing, or the like. The network may be configured to communicate data via a wireless and/or a wired communication medium. The network may include any one or more of the following topologies, including, for example, a point-to-point topology, a bus topology, a linear bus topology, a distributed bus topology, a star topology, an extended star topology, a distributed star topology, a ring topology, a mesh topology, a tree topology, or the like.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, or the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise in addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may he described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may he used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media ay include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

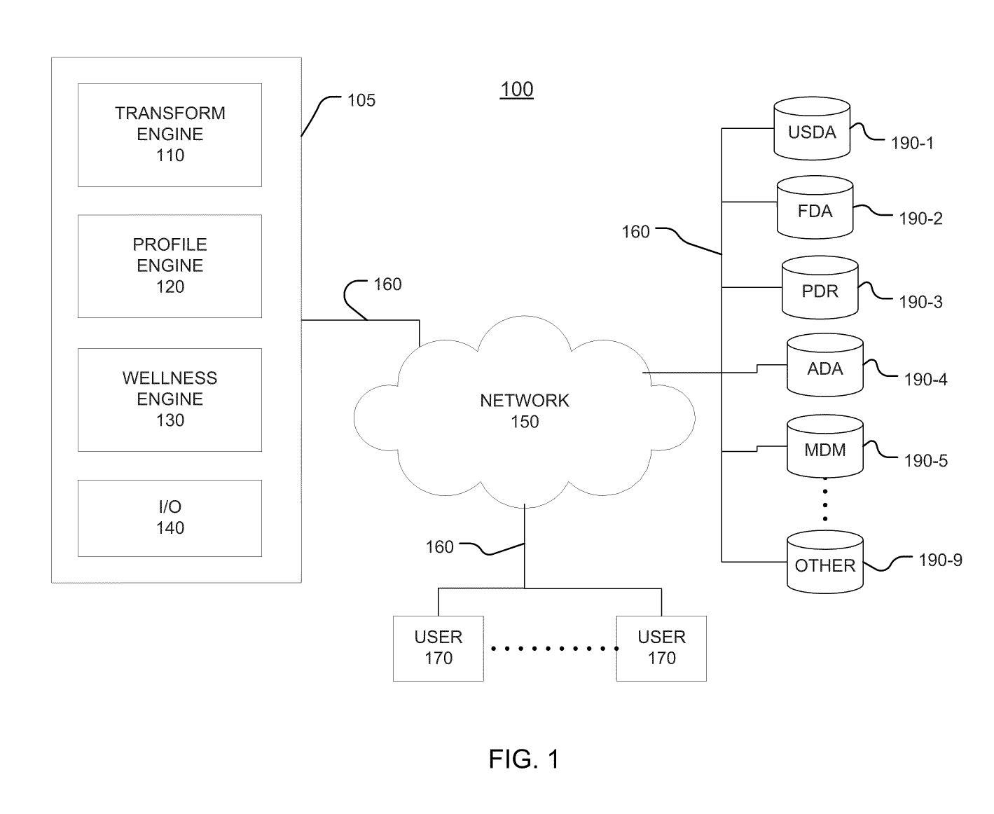

FIG. 1 shows an example of a Conditional System (CS) 100, according to principles of the disclosure. The CS 100 includes Conditional Engine (a personal nutrition, health and wellbeing device) 105, a network 150, one or more users 170 and one or more databases 190. The Conditional Engine (CE) 105, users 170 and databases 190 may be connected to the network 150 through a plurality of communication links 160. Each of the CE 105, users 170 and databases 190 may include a computer.

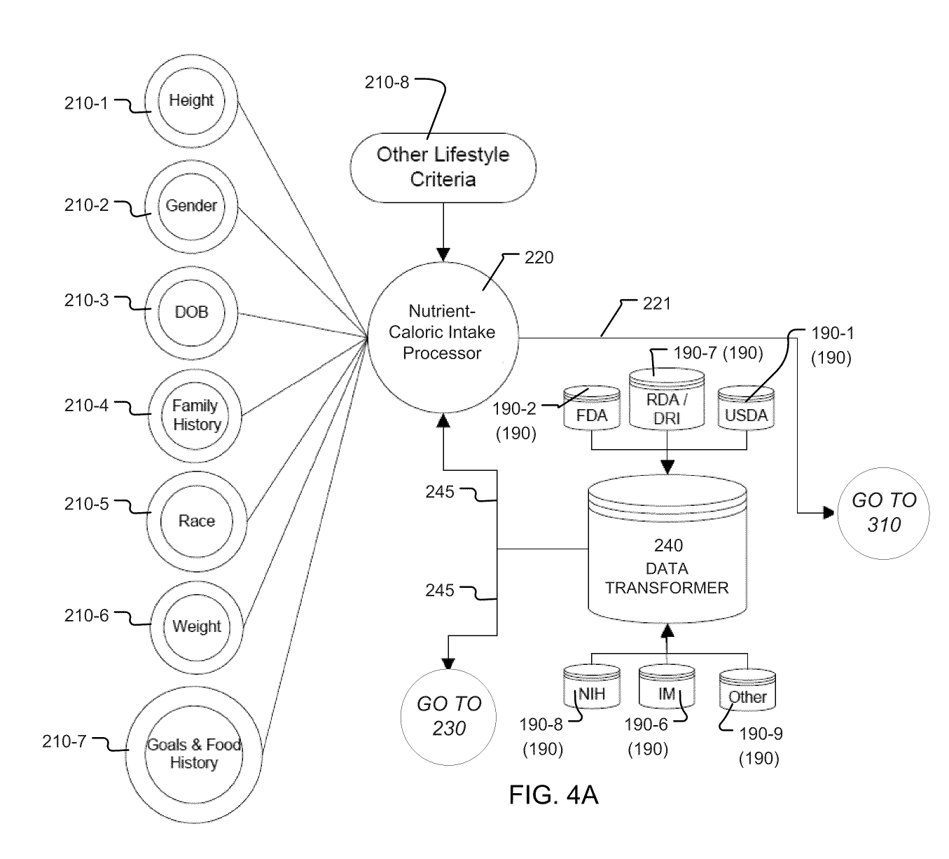

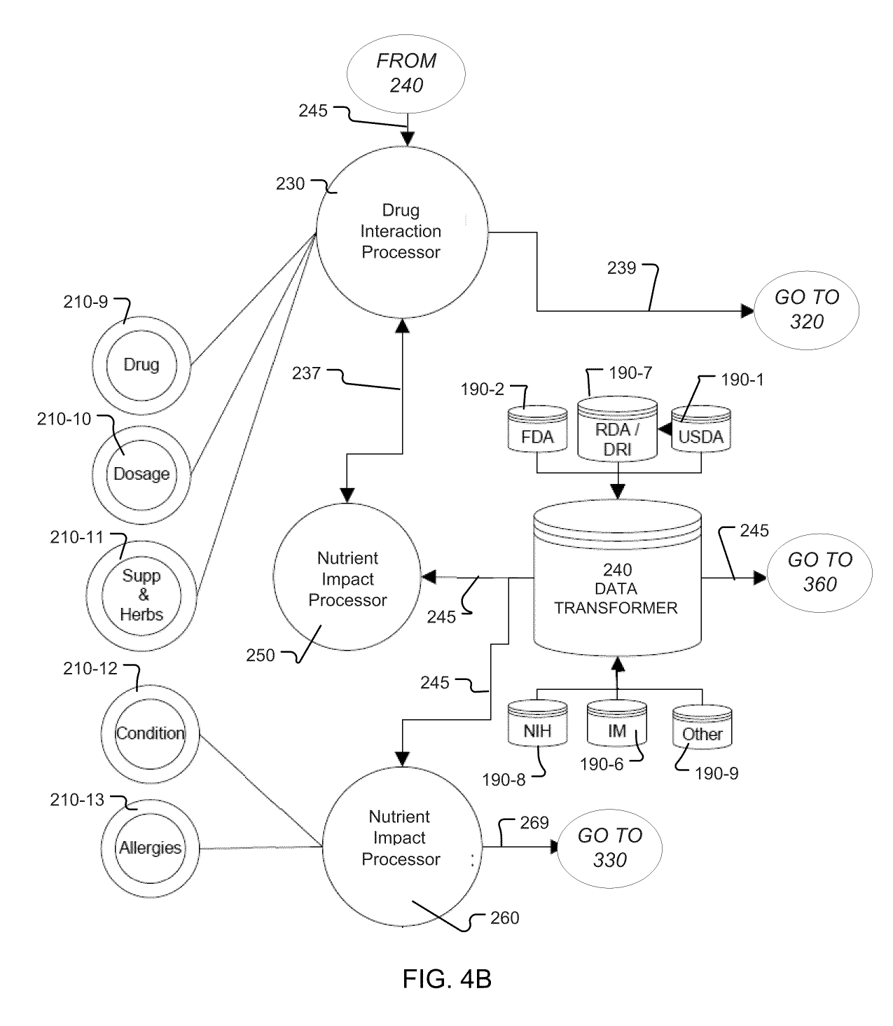

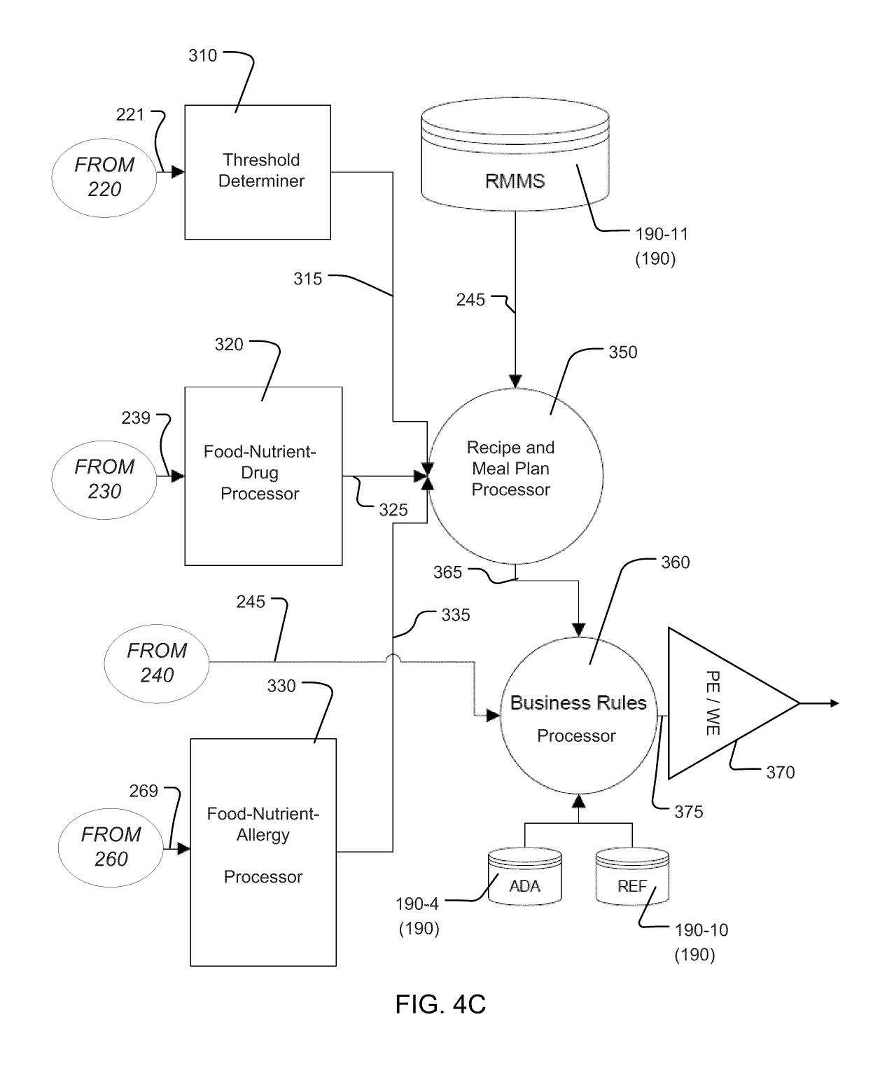

The databases 190 may include, for example, United States Department of Agriculture (USDA) databases 190-1, U.S. Food and Drug Administration (FDA) databases 190-2, Recommended Dietary Allowance (RDA) databases 190-3, American Dietetic Association (ADA) databases 190-4, Morrison Diet Manual (MDM) databases 190-5, Institutes of Medicine (IM) 190-6 (shown in FIG. 4A), Dietary Reference Intake (DRI) databases 190-7 (shown in FIG. 4A), National Institutes of Health (NIH) databases 190-8 (shown in FIG. 4A), other government (or non-government) data sources 190-9, REF databases 190-10 (shown in FIG. 4C), and recipe and menu management system (RMMS) databases 190-11 (shown in FIG. 4C).

The CE 105 may include a Transformation Engine (TE) 110, a Profile Engine (PE) 120, a Wellness Engine (WE) 130 and an input/output (I/O) interface 140. The I/O interface 140 is configured to provide communication between the CE 105, including the TE 110, the PE 120 and the WE 130, and the outside world, including the users 170 and databases 190, through the network 150. The CE 105 may include a computer or server.

The TE 110 may include, for example, one or more application program interfaces (APIs), Open database connectivity (ODBC), or other transport mechanisms, as understood by those having ordinary skill in the art. The TE 110 is configured to access the one or more databases 190 and retrieve source data from the databases 190 (for example, 190-1 through 190-11, shown in FIGS. 1, 4A, 4B, 4C). The TE 110 is further configured to consolidate, aggregate, and process the retrieved source data to provide a unique data set for determining user criteria. Specifically, on the basis of the user information provided by the users 170, the TE 1110 converts and normalizes the source data. The source data may include, for example, food and nutrition data, food supplements data, herbs data, dietary health data, demographic data, over-the-counter (OTC) drug data, prescription data, medical condition data, allergy data, lifestyle data (for example, smoking, alcoholic intake, exercise activity, sleeping patterns, and the like), and the like, and any related research, guidelines, discussions, publications, blogs, laws, rules, or the like, related to the foregoing types of data. The TE 110 is configured to convert and normalize the source data into user criteria.

The TE 110 may be configured as described, for example, in co-pending U.S. patent application Ser. No. 12/813,752, (Attorney Docket No. 4409277-5004), filed on Jun. 11, 2010, titled “Transformation Engine.”

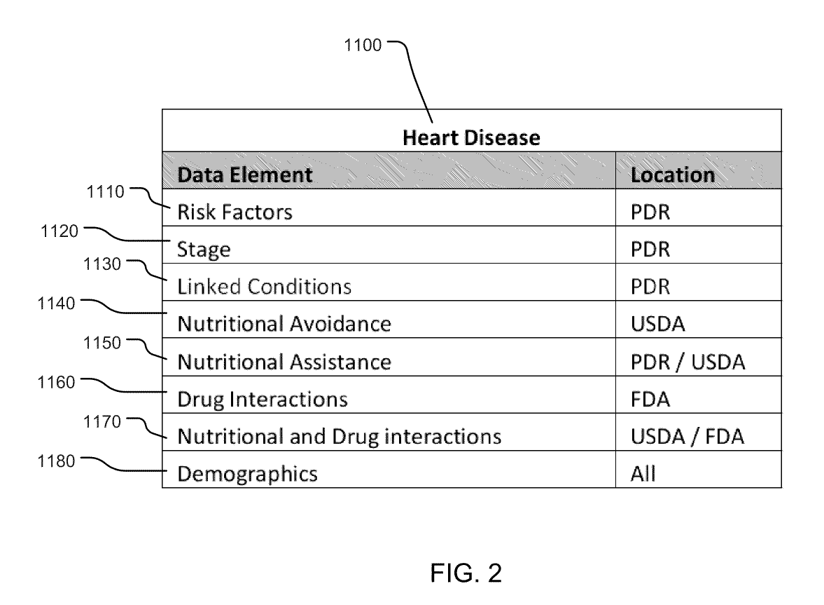

FIG. 2 shows an example of user criteria 1100 that may be determined for a particular medical condition. In this example, the user criteria 1100 includes data related to established medical criteria for heart disease, including, for example: risk factor data 1110 that includes risk factors related to heart disease; stage data 1120 that includes the various stages of heart disease; linked condition data 1130 that includes the various conditions that may be linked to heart disease; nutritional avoidance data 11140 that includes various nutrients that are found to reduce the likelihood of heart disease; nutritional assistance data 1150 that includes various nutrients that are found to increase the likelihood of heart disease; drug interaction data 1160 that includes interactions between the various types of drugs that may he used to treat heart disease, as well as OTC drugs and other prescription drugs; nutritional and drug interaction data 1170 that includes interactions between various nutrients and drugs; demographics data 1180 that includes various demographics related to heart disease; and the like. it is noted that the user criteria 1100 may include data related to other medical conditions, demographic information, and/or the like. The TE 110 is configured to access and retrieve the plurality of data elements 1110 through 1180 from the databases 190.

Referring hack to FIG. 1, in generating the user criteria, the IF 110 may also receive source data from the RMMS database 190-11 (shown in FIG. 4C), which may include, for example, recipe customization at the unit level and analysis of nutritional quality of food based on the ingredients in the food (such as, for example, may be available using the Recipe Menu Management System (RMMS)), and use the received source data along with the user information to generate the user criteria. The user criteria may include, for example, normalized, formatted data, guidelines, and thresholds established for managing specific factors associated with demographics, drugs, medical conditions, allergies, and the like. The user criteria may be output by the IF 110 and provided to the next analysis component, such as, for example, the PE 120 and/or the WE 130.

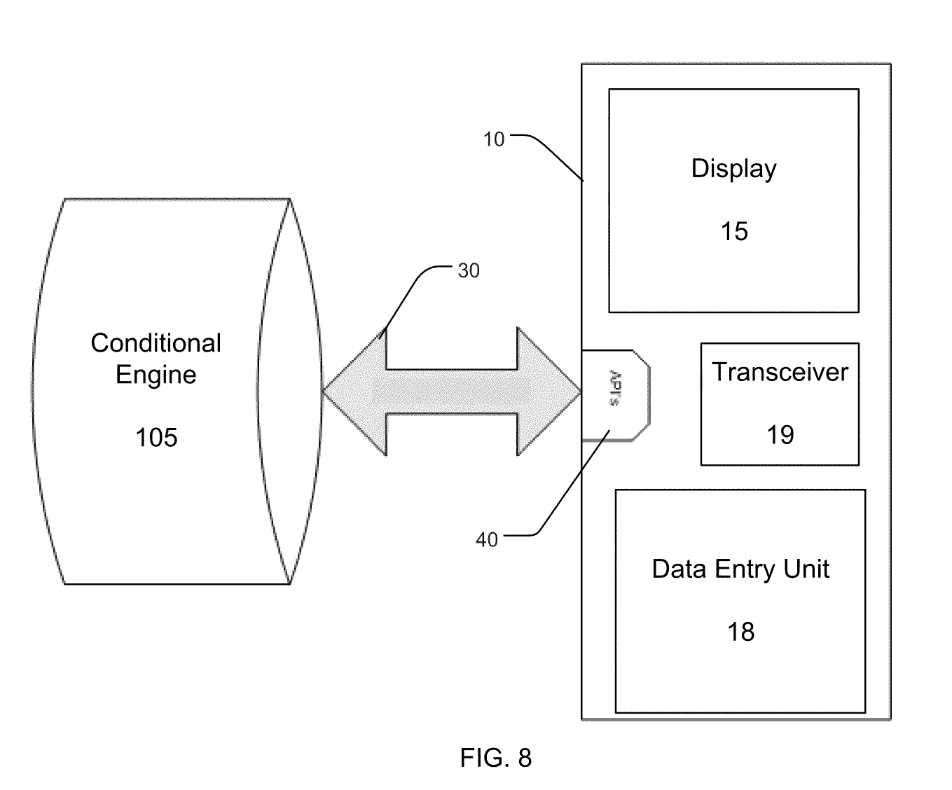

The PE 120 is configured to receive the user criteria from the TE 110 and analyze the user criteria with regard to the user information provided by the users 170 to determine a unique user profile for each user 170. Each user profile may he based on, for example, input selections provided during an initial user information capture session, which may be provided by the user 170 using, for example, the user interface (UI) device 10 shown in FIG. 8 and described below. The user profile for each user 170 may be stored in a local storage (not shown) and updated as the associated user's profile changes over time. The user profile may be supplied from the PE 120 to the WE 130.

The PE 120 may interact with each user 170 via, for example, the 111 device 10 (shown in FIG. 8) to capture the user information from each user 170. The captured user information is then used to generate (or update) a user profile for each user 170. The PE 120 may provide a profile analysis for each user 170 across a wide spectrum of product and/or service offerings from both internal and/or external environments (for example, databases 190) that match the user profile. In this regard, the PE 120 may, for example, compare and match the unique medical condition of a user 170 with the specified factors associated with the medical condition. The PE 120 may then tag specific drugs, nutrients, ingredients, programs, and the like, which should be avoided or encouraged depending on the user information of the user 170, with a code. The PE 120 may output the resultant profile analysis data in the form of the user profile to the WE 130 and/or the user 170. The user profile may include a unique user identifier for interaction with the CE 105. The user profile may include hundreds, or more (or less), demographic and tagged items derived from the user information provided by the users 170.

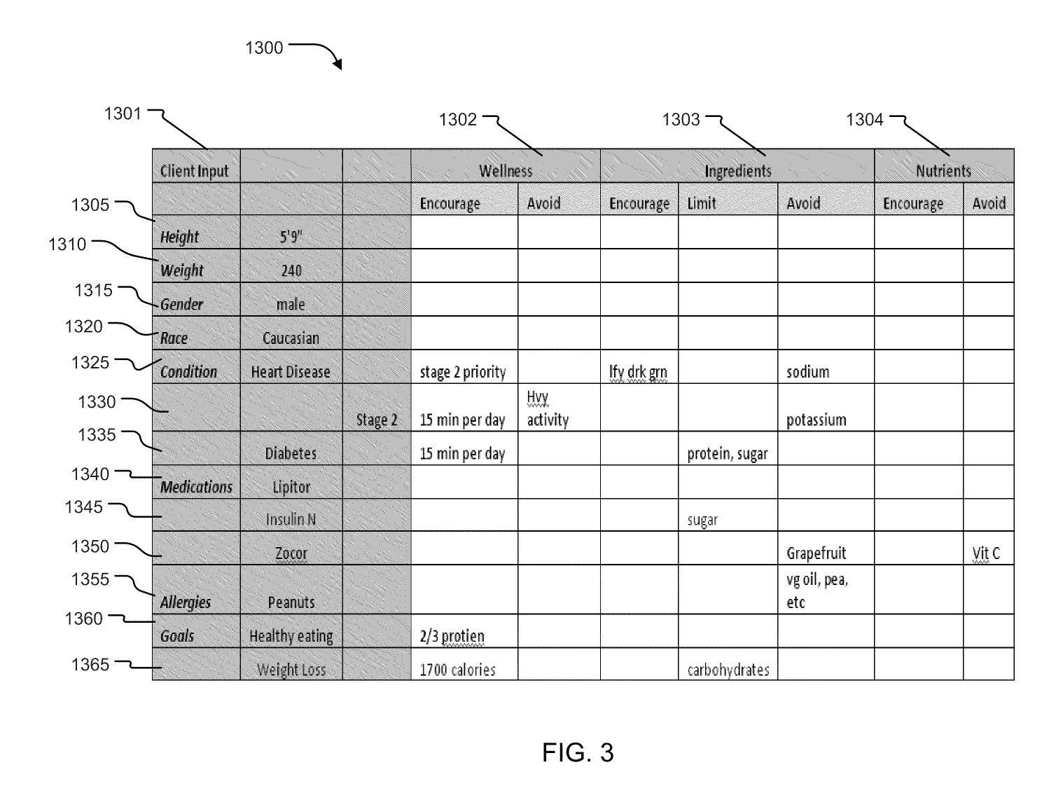

FIG. 3 shows an example of a user profile 1300, according to principles of the disclosure. The user profile 1300 includes, for example, client input data 1301, wellness data 1302, ingredients data 1303, and nutrients data 1304. Each of the wellness data 1302, ingredients data 1303 and nutrients data 1304 may include, for example, two types of data, such as encourage data and avoid data. The encourage data may include an article or an activity that is to be encouraged or recommended for a particular user 170 (shown in FIG. 1), who is associated with the user profile 1300. The avoid data may include an article or an activity that is to be discouraged or avoided by the particular user 170, who is associated with the user profile 1300. The client input data 1301 may include, for example, height data 1305, weight data 1310, gender data 1315, race data 1320, medical condition data 1325-1335, medications or drug data 1340-1350, allergy data 1355, goal data 1360-1365, and the like. The user profile 1300 may include hundreds, or more (or less), of demographic and tagged items derived from the user information.

Referring to FIG. 1, the WE 130 is configured to receive and analyze the user profile and filter product and/or service offerings to lit the user criteria for each user 170. The resultant, filtered conditional-based user data, which includes products and/or services tailored to the particular user, that may span across the wellness and nutrition spectra, including, for example, a meal plan, a diet plan, a recipe, a nutritional conflict, an exercise routine, a shopping list, a restaurant menu, or the like, may be provided to the users 170 via, for example, the UI device 10 (shown in FIG. 8). The product and/or service offerings may include, for example, a recipe, a diet plan, a menu plan, a prepared meal (for example, from an internal and/or external partner), exercise programs (or plans), exercise equipment, a shopping list, a restaurant menu, and the like. The WE 130 may provide a culmination of a detailed conditional analysis that may tailor substantially all products and/or services offered to each user 170 in the CS 100.

A computer readable medium (not shown) may be provided that includes a computer program, which when executed by a computer may cause each of the processes performed in the CE 105 (shown in FIG. 1) to be carried out according to the principles of the disclosure. The computer readable medium may include an instruction (for example, code section or code segment) corresponding to each of the processes.

FIGS. 4A-4C show a flow diagram for the CE 105 provided in the CS 100, according to principles of the disclosure. As seen in FIGS. 4A-4C, the CE 105 may include a nutrient-caloric intake processor 220, a drug-interaction processor 230, a data transformer 240, a nutrient impact processor 260, a threshold determiner 310, a food-nutrient drug processor 320, a food-nutrient allergy processor 330, a recipe and meal plan processor 350, and a business rules processor 360.

It is noted that all communication and data transmission described herein may be unidirectional or bidirectional, as understood by those having ordinary skill in the art. For example, even though the direction of travel of the user criteria on communication link 245 is shown in FIG. 4A as unidirectional, it is noted that the data flow may be bidirectional, wherein, for example, a nutrient-caloric intake processor 220 may send a request, data or information to a data transformer 240.

Referring to FIG. 4A, a user 170 (shown in FIG. 1) may, using the UI device 10 (shown in FIG. 8), input one or more of the following user information 210, including, for example, height data 210-1, gender data 210-2, date of birth (DOB) data 210-3, family history data 210-4, race data 210-5, weight data 210-6, goals and food history data 210-7, other lifestyle criteria data. 210-8, and the like. The user information 210 may be provided to the nutrient-caloric intake processor 220, which may aggregate and process the user information 210 along with user criteria received from the data transformer 240 on a communication link 245 to generate nutrient and caloric intake data 221 for each user 170.

The nutrient-caloric intake processor 220 is configured to access the user criteria from the data transformer 240 and process, for example, nutrient and caloric information that may be retrieved from public and commercial sources against the user information 210 for each user 170. The nutrient-caloric intake processor 220 may output the nutrient and caloric intake data 221, including a set of nutritional and caloric thresholds for intake for each user 170, which are matched to the respective user information 210 for each user 170. The nutrient and caloric intake data 221 may be output to the threshold determiner 310 (shown in FIG. 4C).

The data transformer 240 may be the same as, or similar to the TE 110 (shown in FIG. 1). The data transformer 240 may include one or more application program interfaces (APIs) that may be configured to access any one or more of the databases 190 (for example, 190-1 through 190-11, shown in FIGS. 1, 4A, 4B, 4C), retrieve data from the databases 190, and process the data to generate the user criteria, which may be sent to the nutrient-caloric intake processor 220 and/or the nutrient impact processor 250 on the communication links 245. The data transformer 240 may retrieve source data from disparate sources 190 toward providing a unique user profile for each user 170.

Referring to FIG. 4B, additional user information 210 may be provided by the user 170 by means of the UI device 10 (shown in FIG. 8), including, for example, drug or medication data 210-9, drug dosage data 210-10, food supplements and herbs data 210-11, and the like. This user information 210 may be provided to the drug interaction processor 230. The drug interaction processor 230 may also receive user criteria, via the communication links 245, from the data transformer 240 (shown in FIG. 4A) and nutrient impact data via a communication link 237 from the nutrient impact processor 250. The nutrient impact data may be provided to the drug interaction processor 230 in response to a nutrient impact data request sent from the drug interaction processor 230, via communication link 237, to the nutrient impact processor 250. Based on the user information 210 (for example, the drug data 210-9, the drug dosage data 210-10, and the food supplements and herbs data 210-11), the user criteria, and the nutrient impact data, the drug interaction processor 230 may determine drug interaction data, which may include, for example, an identification of nutrients and drugs and their impact on the drugs, herbs and supplements taken by the user 170. That is, the drug interaction processor 230 may analyze the interaction of the drugs, herbs, supplements and corresponding dosages disclosed by the user 170 in the user information 210 against the user criteria received from the data transformer 240. In this regard, the drug interaction processor 230 may determine a wide spectrum of nutrients and/or drugs that may interact with the drugs, herbs, supplements and corresponding dosages taken by the user 170, including the particular effects and/or severities of the interactions.

The drug interaction processor 230 may output the drug interaction data, via a communication link 239, to the food-nutrient-drug processor 320 (shown in FIG. 4C), which may generate one or more interaction alerts and a unique list of foods and nutrients that may impact the user 170 based on the stated drugs, supplements and corresponding dosages being taken by the user 170. The drug interaction information may include, for example, an identification of drugs, foods, food supplements, activities, and the like, as well as dosages of the foregoing, that may interact with the drugs identified in the drug data 210-9, dosage data 210-10, and supplements and herbs data 210-11 provided by the user 170.

Further user information 210 may be provided by the user 170 via the UI device 10, including, for example, medical condition data 210-12, allergies data 210-13, and the like. This user information 210 may be provided to the nutrient impact processor 260. The nutrient impact processor 260 may be substantially the same as, or similar to the nutrient impact processor 250. The nutrient impact processor 260 receives the user information 210 (for example, condition data 210-12 and allergies data 210-13) from the user 170, as well as the user criteria, from the data transformer 240. On the basis of the user information 210 and user criteria, the nutrient impact processor 260 may generate nutrient impact information, which may be sent on a communication link 269 to the food-nutrient-allergy processor 330 (shown in FIG. 4C). The nutrient impact information may include, for example, an identification of nutrients that are matched to the user information 210, including the condition data 210-12 and allergies data 210-13. For example, depending on the specific diagnosed (or non-diagnosed) medical conditions and allergies (or intolerances) provided by the user 170 in the user information 210, the nutrient impact processor 260 may determine the nutrient impact or conflict of the food, drugs, supplements and/or herbs provided in the user criteria to determine a unique list of foods, drugs, supplement and/or herbs to be taken (or avoided) by the user 170.

Referring to FIG. 4C, the threshold determiner 310 is configured to receive the nutrient and caloric intake data, via the communication link 221, from the nutrient and caloric intake processor 220 (shown in FIG. 4A) and determine specific thresholds for caloric and nutrient intake for each user 170. The specific caloric and nutrient intake thresholds may be output by the threshold determiner 310 and sent to the recipe and meal plan processor 350 via a communication link 315. The specific caloric and nutrient intake thresholds may include a set of thresholds for intake by the user 170, which may be matched to, for example, the user's stated demographic information and goals, that were provided in the user information 210.

The food-nutrient-drug processor 320 may receive the drug interaction data, via the communication link 239, from the drug interaction processor 230 and generate a unique list of food and nutrients that may impact the drugs taken by the user 170. The list may include one or more interaction alerts and a unique list of foods and nutrients that may impact the user 170 based on the stated drugs, supplements and herbs, and corresponding dosages taken by the user 170, as provided in the user information 210. The list of foods and nutrients may be sent to the recipe and meal plan processor 350 via a communication link 325.

The food-nutrient-allergy processor 330 may receive the nutrient impact data, via the communication link 269, from the nutrient impact processor 260 and generate a unique list of food and nutrients that may impact the allergies and conditions stated by the user 170. The list may include a list of foods and nutrients that may impact the allergies and/or medical conditions stated by the user 170, as provided in the user information 210. The list of foods and nutrients may be sent to the recipe and meal plan processor 350 via a communication link 335.

The caloric and nutrient intake thresholds, and the lists output by the food-nutrient drug processor 320 and the food-nutrient allergy processor 330, may be provided to the recipe and meal plat processor 350. Once the caloric and nutrient intake thresholds and the lists have been established for each unique user 170, that information may be processed against an a very large quantity (e.g., thousands, millions, or the like) of recipes, meal plans, programs, food products, restaurant menus, and the like, received in nutrient analysis data, via the communication link 245, from the recipes and meal plans database RMMS 190-11. For example, leveraging the nutritional, recipe and menu management data, the user profiles for each of the users 170 may be applied against the food and nutrient items to determine possible recipes, meal plans, restaurant menus, shopping lists, activities and programs for each user 170. The recipe and meal plan processor 350 may process the recipes, meal plans, restaurant menus, shopping lists, ingredients and nutrient analysis data against, for example, the caloric and nutrient intake thresholds, the list of foods and nutrients that may impact the drugs taken by the user 170, and the list of foods and nutrients that may impact the allergies and conditions stated by the user 170. The recipe and meal plan processor 350 may generate pre-filtered output data, which may include a plurality of options of recipes, food products, restaurant menus, and meal plans for the particular user 170. The pre-filtered output data may be forwarded to the business rules processor 360 via a communication link 365. The business rules processor 360 may process the pre-filtered output data against bench marks for each of the data categories to generate the filtered conditional-based user data, which may then be output to the PE 120, the WE 130, and/or the user 170 (shown in FIG. 1). The filtered conditional-based user data may include the optimal products and/or services tailored to the particular user 170, which may include, for example, an optimal meal plan, an optimal diet plan, an optimal recipe, a nutritional conflict, an optimal exercise routine, an optimal shopping list, an optimal restaurant menu, or the like. The filtered conditional-based user data may also include optional products and/or services, which may be equivalent to, or less than optimal for the particular user.

A computer readable medium (not shown) may be provided that includes a computer program, which when executed by a computer may cause each of the processes performed in the CE 105 of FIGS. 4A-4C to be carried out according to the principles of the disclosure. The computer readable medium may include an instruction (for example, code section or code segment) corresponding to each process.

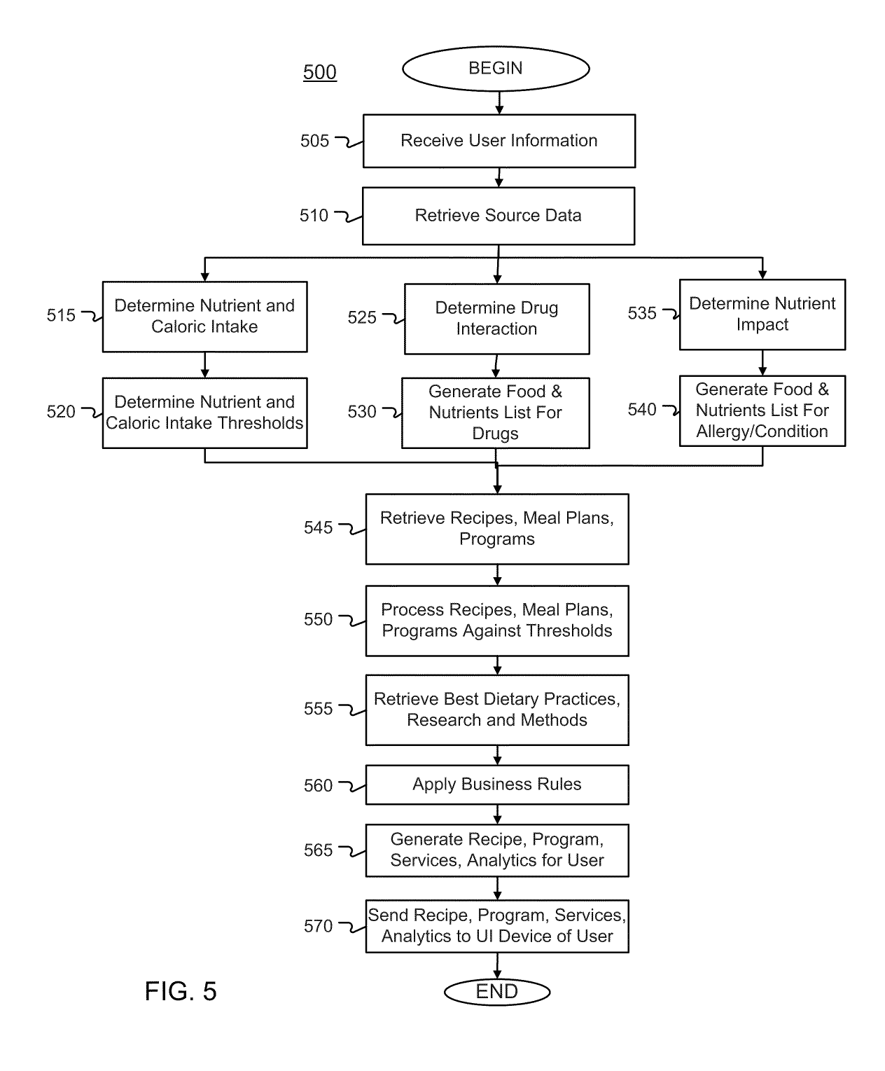

FIG. 5 shows an example of a process 500 for generating and outputting a host of custom-tailored recipes, meal plans, programs, shopping lists, restaurant menus, analytics, and the like, to each of the users 170, according to principles of the disclosure.

Referring to FIG. 5 in conjunction with FIGS. 1 and 4A-4C, the CE 105 receives the user information 210 from one or more users 170 via respective 111 devices 10 (Step 505). The CE 105 retrieves source data, including, for example, demographic data, OTC drug data, prescription data, medical condition data, and the like (Step 510). On the basis of the user information 210 and source data, the CE 105 may generate user criteria, which may be used by, for example, the PE 120 to generate (or update an existing) a user profile for each of the users 170, which may include nutrient and caloric intake data (Step 515) and nutrient and caloric intake thresholds (Step 520) for each user 170. Also based on the user information 210 and source data, the CE 105 may determine drug interaction data (Step 525) and generate a foods and nutrients list with regard to the drug data 210-9, dosage data 210-10, and supplements and herbs data 210-11 for each user 170 (Step 530). Additionally, also based on the user information 210 and source data, the CE 105 may determine nutrient impact data (Step 535) and generate a list of foods and nutrients with regard to the allergy data 210-13 and medical condition data for each user 170 (Step 540). While shown as being carried out at substantially the same time, the Steps 515, 525, 535, may be carried out at different times. Similarly, the Steps 520, 530, 540, may be carried out at substantially the same time or at different times.

After obtaining the nutrient and caloric intake thresholds and the lists of foods and nutrients, the CE 105 may retrieve recipes, meal plans, food products, restaurant menus, and programs from, for example, the RMMS 190-11 and/or a local database 190-9, which may be populated with data related to available products (e.g., food products, drug products, exercise equipment, health products, and the like) and service providers (e.g., restaurants, gyms, drug stores, and the like) (Step 545). The CE 105 may process the retrieved recipes, meal plans, food products, restaurant menus, and programs against the nutrient and caloric intake thresholds and the lists of foods and nutrients (Step 550). The CE 105 may retrieve the best dietary practices, research and methods rules from, for example, the ADA database 190-4 and the REF database 190-10 (Step 555). The CE 105 may generate business rules on the basis of the retrieved best dietary practices, research and methods information (or bench marks) and apply the business rules to the recipes, meal plans, shopping lists, restaurant menus, and programs on the basis of the nutrient and caloric intake thresholds and the foods and nutrients lists (Step 560). The CE 105 may generate recipes, programs, shopping lists, restaurant menus, services, analytics, and the like, tailored to each individual user 170 (Step 565). The CE 105 may send the generated recipes, programs, shopping lists, restaurant menus, services, analytics, and the like, to the particular UI device 10 associate with the individual user 170 (Step 570).

A computer readable medium (not shown) may be provided that includes a computer program, which when executed by a general purpose computer, may cause each of the Steps 505 through 570 to be carried out according to the principles of the disclosure. The computer readable medium may include a code section (or segment) corresponding to each of the Steps 505 through 570.

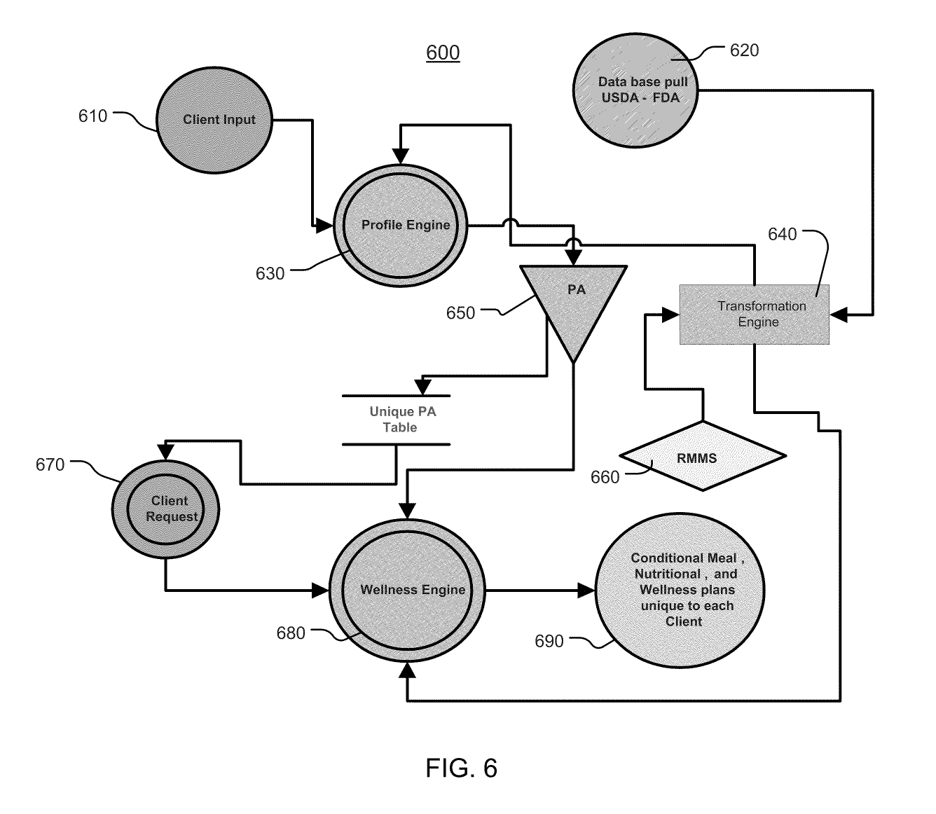

FIG. 6 shows another, simplified example of a process 600 that may be carried out by the CE 105 (shown in FIG. 1), according to principles of the disclosure.

Referring to FIGS. 1 and 6, the PE 120 may interact with the UI device 110 associated with a particular user 170 (Step 610) to capture specific user (or client) information, such as, for example, but not limited to, all conditions, medications, and the like, for the particular user 170 (Step 630). The PE 120 may also interact with the TE 110 to receive user criteria (for example, medical criteria 1100 shown in FIG. 2) (Step 640). The TE 110 may receive customized recipes at the unit level and analysis of nutritional quality of food based on the ingredients in food from, for example, the RMMS, or the like (Step 660). The PE 120 may provide a (new or updated) user profile that includes an analysis across a wide spectrum of product offerings from both internal and/or external environments based on the user information, source data and wellness criteria (Step 650). In this regard, the PE 120 may compare and match a unique condition provided in the user information with the specified factors associated with the condition, as determined, for example, from the received user criteria. The PE 120 may then tag specific nutrients, ingredients, programs, and the like, with a code that should be avoided or encouraged depending on the unique condition of the user 170. The PE 120 may output the resultant user profile to the WE 130 (Step 680) and/or the user 170 (Step 670). The user profile may include, for example, the table 1300 shown in FIG. 3. The user profile may include a unique user identifier for interaction with the CE 105, which may be included in the information 30 communicated between the UI device 10 and CE 105. The user profile may include hundreds, or more (or less), demographic and tagged items derived from the user information.

The WE 130 may receive the user profile (for example, table 1300, shown in FIG. 3) and filter product and/or service offerings to the fit the conditions of the user 170 determined from the user profile (Step 690). The product/service offerings may include, for example, a recipe, a diet plan, a menu plan, a prepared meal (for example, from an internal and/or external partner), exercise programs (or plans), exercise equipment, a shopping list, a restaurant menu, and the like. The product/service offerings may be communicated to the UI device 10 of the user 170 and displayed to the user on, for example, a display (not shown) of the UI device 10 (shown in FIG. 8).

All three components, i.e., the TE 110, the PE 120 and the WE 130 make up the CE 105. The CE 105 may provide a tailored approach to wellness, nutrition, and diet for each user 170. The CE 105 may be used in the contract food services (such as, for example, health care, assisted living communities, or the like), or the like.

According to a further aspect of the disclosure, a computer program may be provided embodied in a computer readable medium, which when executed on a computer in the CE 105 (or TE 110, or PE 120, or WE 130) may cause Steps 610 through 690 of the process 600 to be carried out. The computer readable medium may include a code section (or segment) associated with each of the Steps 610 through 690.

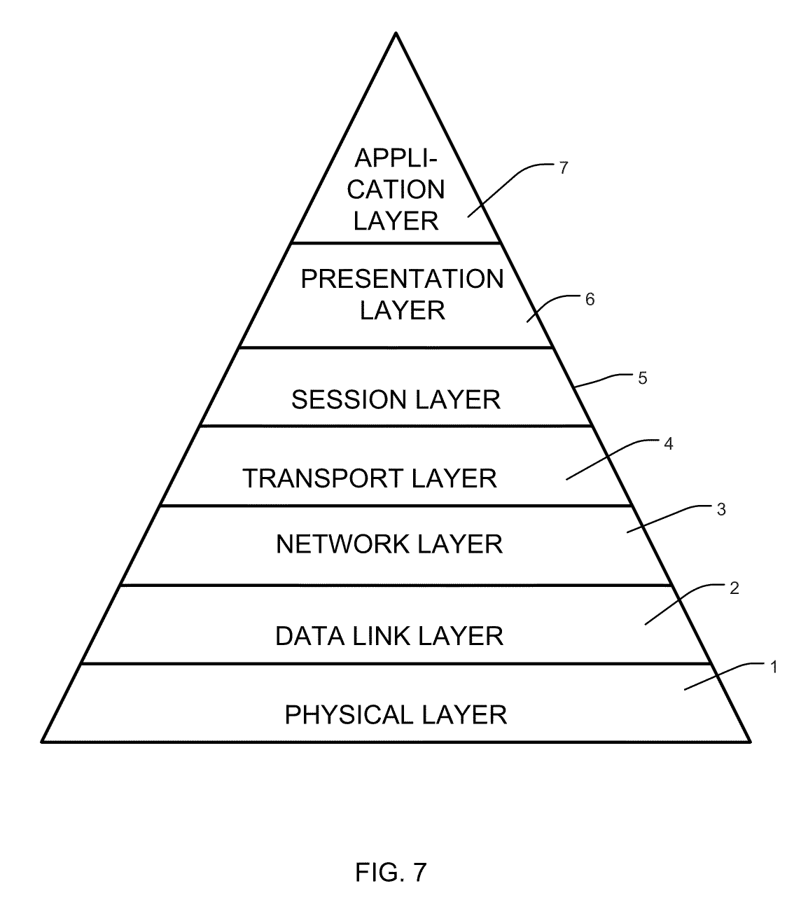

FIG. 7 illustrates a representation of the seven-layer OSI framework model of networking, which was developed by the International Organization for Standardization (ISO) that may be implemented in, e.g., the CS 100 (shown in FIG. 1). The OSI model includes a physical layer 1, a data link layer 2, a network layer 3, a transport layer 4, a session layer 5, a presentation layer 6, and an application layer 7. In a networking system that is configured in accordance with the OSI model, one or more entities within each layer 1-7 implement the functionality of the particular layer. Each entity interacts directly only with the layer immediately beneath it, while providing facilities for use by the layer above it. Protocols enable an entity in one host to interact with a corresponding entity at the same layer in another host. Service definitions abstractly describe the functionality provided to an n-layer by an n−1 layer, where n is one of the seven layers in the OSI model of protocols operating in the local host.

FIG. 8 shows an example of a user interface (UI) device 10 that may be used by the users 170 (shown in FIG. 1) to communicate with the CE 105 over a communication link 20 via the network 150 (shown in FIG. 1). In this regard, information 30 may be communicated between the UI device 10 and the CE 105. The information 30 may include the user information 210, one or more security protocols to transfer and interact in a network environment, the user profile associated with the particular user 170, the host of custom-tailored recipes, meal plans, programs, analytics, shopping lists, restaurant menus, compatible food locations, and the like. The UI device 10 includes a computer (or processor) (not shown), a display 15, a data entry unit 18, and a transceiver 19. The data entry unit 18 may include, for example, a keyboard. The data entry unit 18 may be integrated with the display 15 into a single device (not shown), such as, for example, a touch-screen display. The transceiver 19 includes a transmitter (not shown) and a receiver (not shown), both of which are configured to communicate with the CE 105 via the communication links 160 and the network 150, as seen in FIG. 1.

The UI device 10 may include, for example, a mobile computer, a smart phone (e.g., Apple's iPhone, Apple's iPad, RIM's Blackberry, Motorola's Droid, Google phone, Palm's Pre, or the like), or the like. The UI device 10 may further include a speaker and a microphone.

The UI device 10 also includes one or more application program interfaces (APIs) 40. The one or more APIs 40 (referred to in the singular as “API” for ease of reference) may be configured to operate at the application layer 7 of the OSI model. The API 40 may be platform independent and configured to connect, for example, to an online web-based environment on the network 150. The API 40 is configured to share and exchange the information 30, which may be specific to the user 170, or which may be specific to a particular session between the Iii device 10 and CE 105. The information 30 may be secured via unique security and encryption protocols to ensure privacy and fidelity of information.

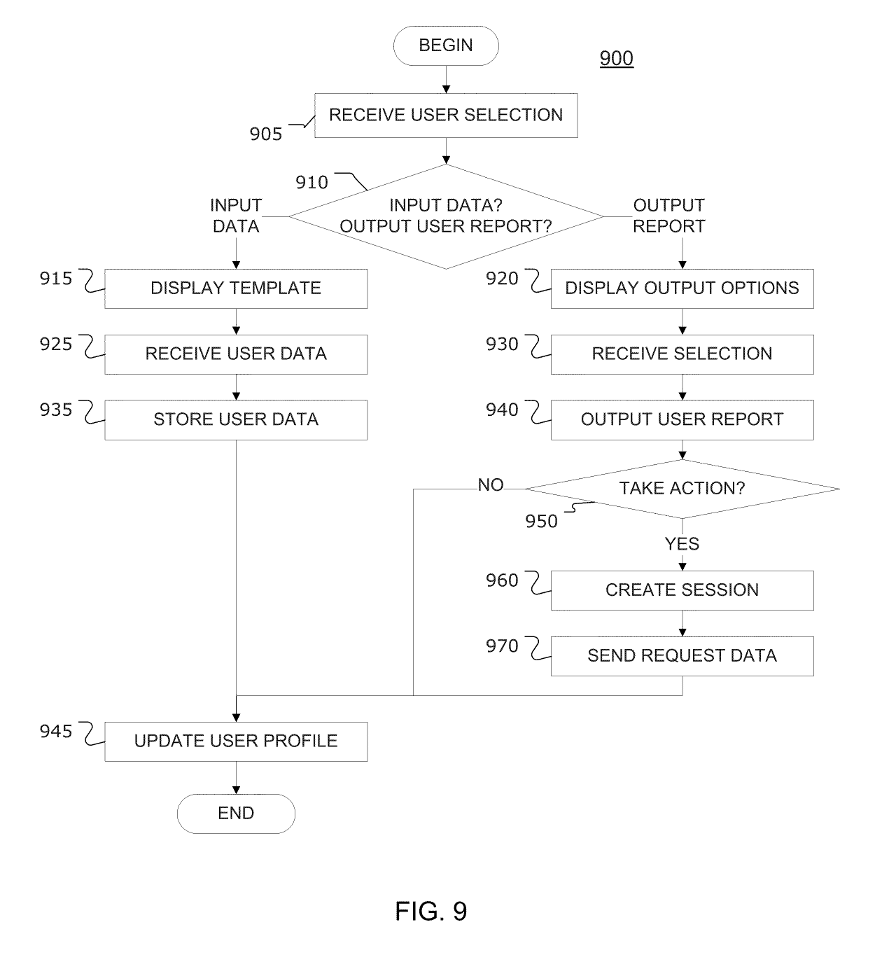

FIG. 9 shows an example of a process 900 that may be carried by the API 40 on the UI device 10 (shown in FIG. 8). The process may begin with, for example, a selection of an icon by the user 170 on the UI device 10. In response to activation of the API 40, the API 40 may present the user 170 with a display of one or more options, including, for example, an option to update or edit the user profile, input user information 210, display the user profile, output a user report, and the like. A user selection of a desired option may be received by the API 40 (Step 905). In response to the user selection, a determination may be made whether the user elected to input user information 210 or update/edit the user profile (“INPUT DATA” at Step 910), or the user elected to output a user report that is associated with the particular user 170 (“OUTPUT REPORT” at Step 910.

If the user 170 elected to input user information 210 or to update/edit the user profile (“INPUT DATA” at Step 910), then the API 40 may display a data entry template (Step 915), which includes a plurality of data entry fields, instructions, and the like. The API 40 may also display the current user profile associated with the user 170. The API 40 may then receive the user information 210 entered by the user 170, or user profile changes/updates provided by the user 170 in the entry fields of the template displayed on the UI device 10 (Step 925). The received user information 210 and/or user profile changes may be stored in a local storage (not shown) and/or communicated to the CE 105 as information 30 over a communication link (Step 935). The user profile associated with the user 170 may be updated with the received user information 210 (Step 945).

If the user 170 elected to output a user report. (“OUTPUT REPORT” at Step 910), then one or more output options may be displayed on the UI device 10 (Step 920). The user's selection of a desired output option may be received (Step 930), and an associated user report generated and output to the user 170 on the UI device 10 (Step 940). The user report may include, for example, a custom-tailored recipe, a meal plan, a program (e.g., diet program, exercise program, or the like), analytics, a shopping list, a restaurant menu, a list of compatible food locations, and the like. The compatible food locations may include food service establishments such as, for example, restaurants, delicatessens, or the like, that serve food that is compatible with, for example, the dietary needs of the user 170, including avoidance of allergens, and the like.

After outputting the user report (Step 940), a determination may be made whether the user 170 wishes to take action with regard to the output user report (Step 950). In this regard, a determination may he made whether the user 170 has elected to, for example, place an order in an affiliated food store to purchase one or more items on the shopping list, reserve a table at a selected compatible food location, and the like.

If the user 170 elects to take action with regard to the output user report (“YES” at Step 950), then a communication session may be established with, for example, a product provider (e.g., a food store, a drug store, or the like) and/or service provided (e.g., a compatible restaurant, a gym, or the like) (Step 960), and a request data may be communicated to, for example, purchase one or more items on the shopping list, reserve a table at a compatible restaurant, and the like (Step 970), otherwise the user profile may be updated (“NO” at Step 950). The request data may include data that is needed to complete the requested action, including, for example, the user's name, a user account identification number, a product or service that is requested, a delivery/reservation date, a delivery/reservation time, and the like. The user profile associated with the user 170 may be updated with the output user report and any actions that may have been taken on the part of the user 170 (Step 945).

The UI device 10 may be equipped with voice recognition software, speech synthesis software, language translation software, and the like. Accordingly, the UI device 10 may receive spoken information in lieu of, or in addition to data entered by the user 170. The UI device 10 may output the user report in spoken form, including languages other than the spoken or native language of the user 170.

According to a further aspect of the disclosure, a computer program may be provided embodied in a computer readable medium, which when executed on a computer in the UI device 10 may cause Steps 905 through 970 to be carried out. The computer readable medium may include a code section (or segment) associated with each of the Steps 905 through 970.

Although the disclosure has been provided with reference to several embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather, the disclosure extends to all functionally equivalent structures, methods, and uses such as are within the scope of the appended claims.

For example, the databases 190 may include a database (e.g., DB 190-9) of a restaurant, or a chain of restaurants that provides access to the data transformer 240. The database (e.g., 190-9) may be populated with source data for all, or fewer than all, products and/or services offered. The source data may include, for example, recipes, ingredients, quantities of ingredients and the like. The data transformer 240 may subsequently access the source data and process the data in the CE 105 by comparing all, or fewer than all of the products and/or services offered by the restaurant (or chain of restaurants) against each (or a particular) user profile 170. The CE 105 may then include certain (or all) of the products and/or services offered by the restaurant to one or more users 170. For instance, meals from a particular restaurant that caters to customers who have a peanut allergy, may be included in the user profiles of users 170 that may have a peanut allergy.

In accordance with various embodiments of the present disclosure, the methods described herein are intended for operation as software programs running on a computer. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed (processing, parallel processing, or virtual machine processing can also be constructed to implement the methods described herein.

While the disclosure has been described in terms of example embodiments, those skilled in the art will recognize that the invention can be practiced with switchable modifications in the spirit and scope of the appended claims. These examples given above are merely illustrative and are not meant to be an exhaustive list of all possible designs, embodiments, applications or modifications of the disclosure.

What is claimed is:

1. A personal nutrition, health and wellbeing device for receiving user information and providing filtered conditional-based user data to a user based on the user information, the device comprising:
a data transformer that retrieves source data from a database and generates user criteria based on the user information and the source data;
a nutrient-caloric intake processor that receives the user criteria from the data transformer and processes the user criteria against nutrient and caloric information to generate nutrient and caloric intake data; and
a business rules processor that generates the filtered conditional-based user data based on the nutrient and caloric intake data and sends the filtered conditional-based user data to a user interface device.

2. The device of claim 1, wherein the user information comprises:
a height of the user;
a gender of the user;
a date of birth date of the user;
a family history of the user;
a race of the user;
a weight of the user;
a goals and food history of the user;
a lifestyle criteria of the user;
a drug to be taken by the user;
a dosage of the drug;
a supplement to be taken by the user;
a medical condition of the user; or
an allergy of the user.

3. The device of claim 1, wherein the filtered conditional-based user data comprises:
a recipe;
a meal plan;
a diet plan;
a nutritional conflict;
an exercise routine;
a shopping list; or
a restaurant menu.

4. The device of claim 1, further comprising:
a threshold determiner that receives the user criteria from the data transformer and the nutrient and caloric intake data from the nutrient-caloric intake processor and determines caloric and nutrient intake thresholds for the user.

5. The device of claim 1, further comprising:
a drug impact processor that receives a nutrient impact data request for a nutrient and generates drug impact data for the nutrient.

6. The device of claim 5, further comprising:
a drug interaction processor that receives the user criteria from the data transformer and the nutrient impact data from the drug impact processor and generates drug interaction data.

7. The device of claim 6, further comprising:
a food-nutrient-drug processor that receives the drug interaction data from the drug interaction processor and generates a list of food and nutrients that may impact a drug.

8. The device of claim 5, further comprising:
a food-nutrient-allergy processor that receives the nutrient impact data and generates a list of food and nutrients that may impact an allergy or a condition of the user.

9. The device of claim 4, further comprising:
a drug impact processor that receives a nutrient impact data request for a nutrient and generates drug impact data for the nutrient;
a drug interaction processor that receives the user criteria from the data transformer and the nutrient impact data from the drug impact processor and generates drug interaction data;
a food-nutrient-drug processor that receives the drug interaction data from the drug interaction processor and generates a list of food and nutrients that may impact a drug; and
a recipe and meal plan processor that receives the caloric and nutrient intake thresholds for the user from the threshold determiner, the list of food and nutrients that may impact the drug, and generates pre-filtered output data,
wherein the filtered conditional-based user data is generated based on the pre-filtered output data.

10. A method for providing information related to personal nutrition, health and wellbeing of a user, the method comprising:
receiving user information from a user interface device;
generating a user profile based on the user information;
retrieving source data from a database;
determining nutrient and caloric intake data based on the user profile and the retrieved source data;
generating filtered conditional-based data based on the nutrient and caloric intake data and the user profile; and
sending the filtered conditional-based data to the user interface device.

11. The method of claim 10, further comprising:
determining drug interaction data based on the user profile and the retrieved source data.

12. The method of claim 10, further comprising:
determining nutrient impact data based on the user profile and the retrieved source data.

13. The method of claim 10, further comprising:
determining a nutrient intake threshold or a caloric intake threshold based on the nutrient and caloric intake data.

14. The method of claim 11, further comprising:
generating a list of foods and nutrients for a drug based on the drug interaction data and the user profile.

15. The method of claim 12, further comprising:
generating a list of foods and nutrients for an allergy or a condition based on the nutrient impact data and the user profile.

16. The method of claim 10, wherein the user information comprises:
a height of the user;
a gender of the user;
a date of birth date of the user;
a family history of the user;
a race of the user;
a weight of the user;
a goals and food history of the user;
a lifestyle criteria of the user;
a drug to be taken by the user;
a dosage of the drug;
a supplement to be taken by the user;
a medical condition of the user; or
an allergy of the user.

17. The method of claim 10, wherein the filtered conditional-based user data comprises:
a recipe;
a meal plan;
a diet plan;
a nutritional conflict;
an exercise routine;
a shopping list; or
a restaurant menu.

18. The method of claim 10, wherein the generating the filtered conditional-based data based on the nutrient and caloric intake data and the user profile comprises:
generating a business rule based on a retrieved bench mark; and
applying the business rule to pre-filtered output data to generate the filtered conditional-based data.

19. A computer readable medium comprising a computer program for providing information related to personal nutrition, health and wellbeing of a user, the medium comprising:
a user information receiving code section that, when executed on a computer, receives user information from a user interface device;
a user profile generating code section that, when executed on the computer, generates a user profile based on the user information;
a source data retrieving code section that, when executed on the computer, retrieves source data from a database;
a nutrient and caloric intake determining code section that, when executed on the computer, determines nutrient and caloric intake data based on the user profile and retrieved source data;
a filtered conditional-based data generating code section that, when executed on the computer, generates filtered conditional-based data based on the nutrient and caloric intake data and the user profile; and
a filtered conditional-based data sending code section that, when executed on the computer, sends the filtered conditional-based data to the user interface device.

20. The medium of claim 19, further comprising:
a drug interaction determining code section that, when executed on the computer, determines a drug interaction based on the user profile and the retrieved source data;
a nutrient impact determining code section that, when executed on the computer, determines a nutrient impact based on the user profile and the retrieved source data;
a nutrient and caloric intake threshold determining code section that, when executed on the computer, determines a nutrient intake threshold or a caloric intake threshold based on the nutrient and caloric intake data;
a list of foods and nutrients for a drug generating code section that, when executed on the computer, generates a list of foods and nutrients for a drug based on the drug interaction and the user profile;
a list of foods and nutrients for an allergy or condition generating code section that, when executed on the computer, generates a list of foods and nutrients for an allergy or a condition based on the nutrient impact and the user profile.
